(19) United States
(12) Patent Application Publication
(10) Pub. No.: US 2008/0183513 A1
(43) Pub. Date: Jul. 31, 2008

(54) Reengineering event-driven field processes with a self-managed team approach

(76) Inventor: Brian George Keedwell, Rockville, MD (US)

Correspondence Address: BRIAN KEEDWELL, c/o MEZA, EKENSBERGSV. 102 N2, STOCKHOLM, 117 69, SE

(21) Appl. No.: 10/405,937

(22) Filed: Jan. 9, 2004

(51) Int. Cl. G06F 17/60

(52) U.S. Cl. 705/7

(57) ABSTRACT

The invention provides a globally scalable, business-to-business (B2B) Mobile Process Service (MPS) that creates value for users and furthermore, through a franchise arrangement, allows value to be captured especially by telecom service providers. The MPS is characterized by conducting mass-customized, event-driven processes with teams dynamically maintained by requisition of these resources from virtual competence centers using an information system that notifies team members of changes of state that require activity. The information required, derived from both the field and from back-office, to execute that activity is made available at local, single-user server, distributed-databases maintained by replication over packet-switched radio. This required information is identified from business process object collaboration models in which the parameters (rows/columns) are specified in the modelled messages between the business objects. Main and supporting process frameworks are specified.

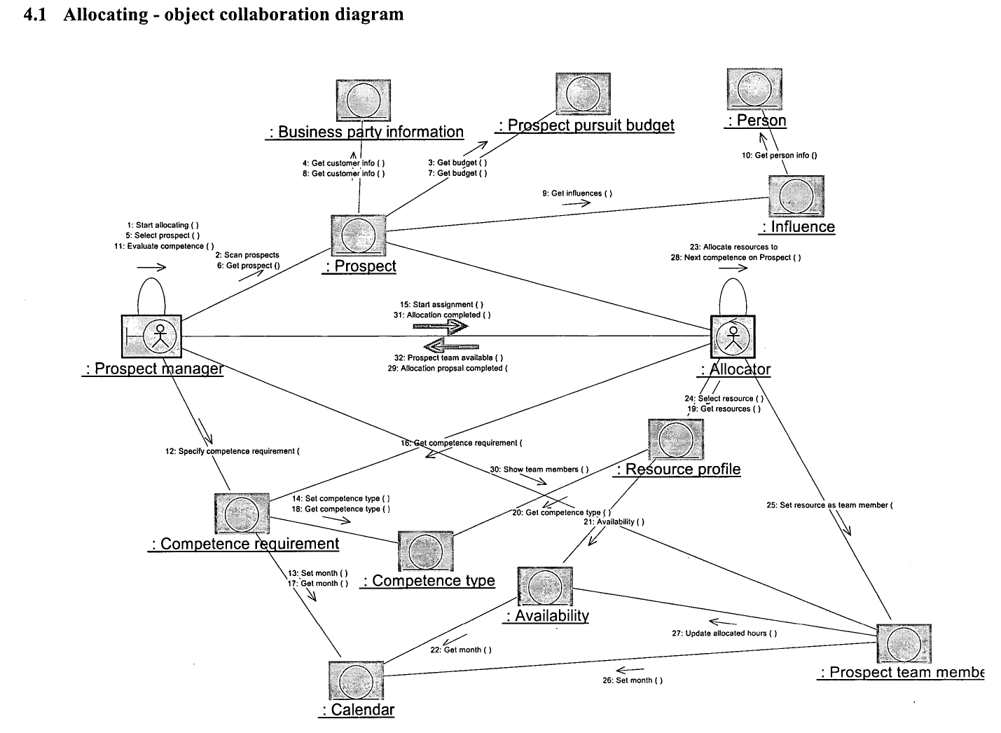

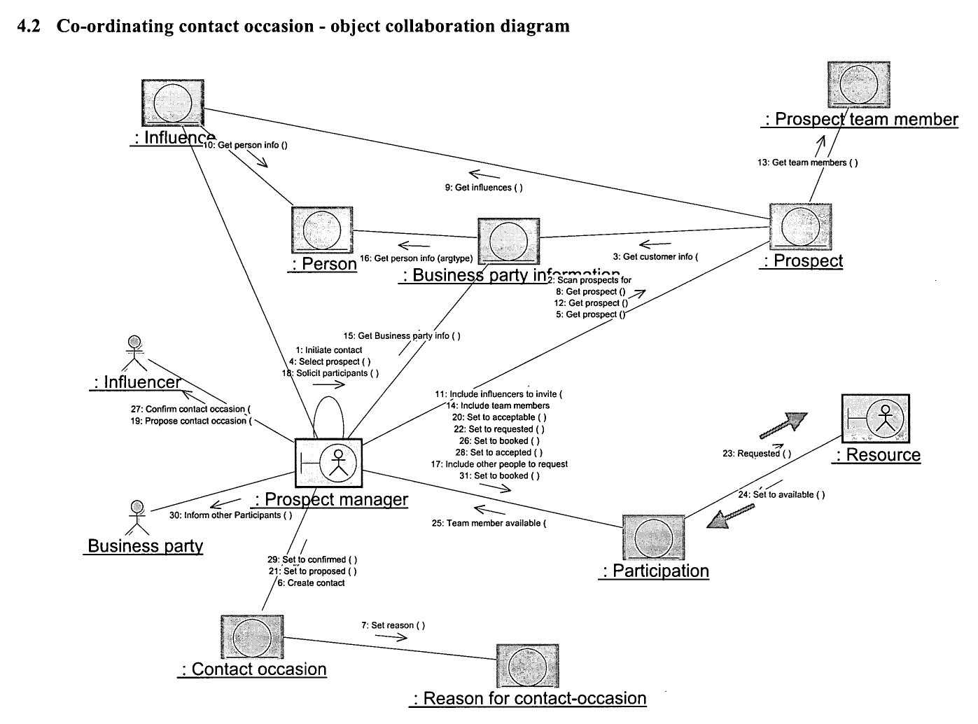

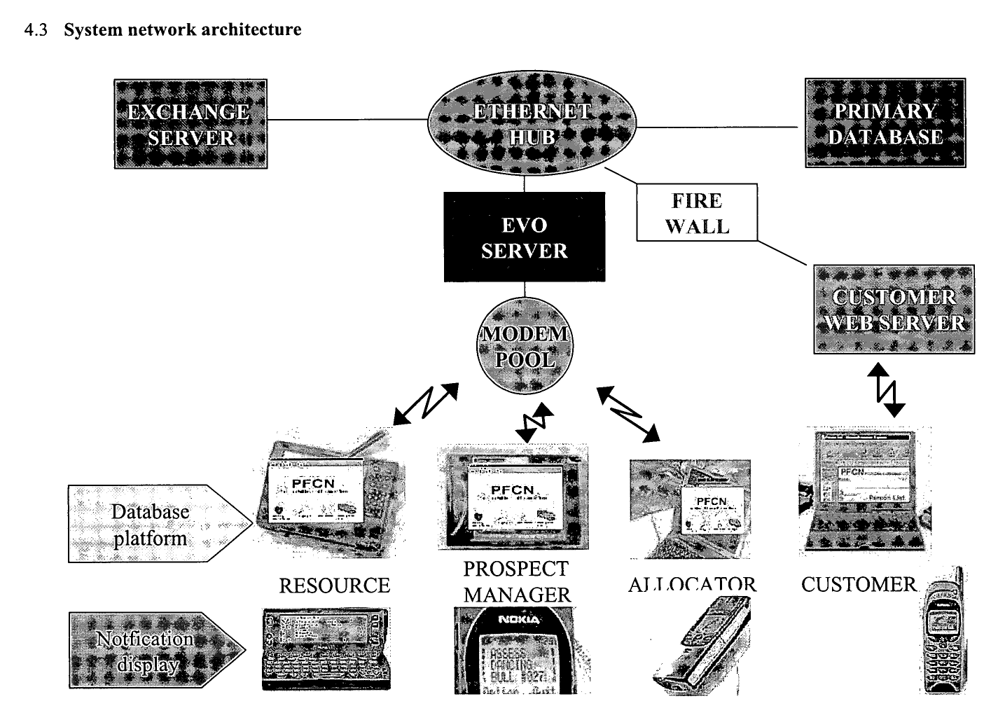

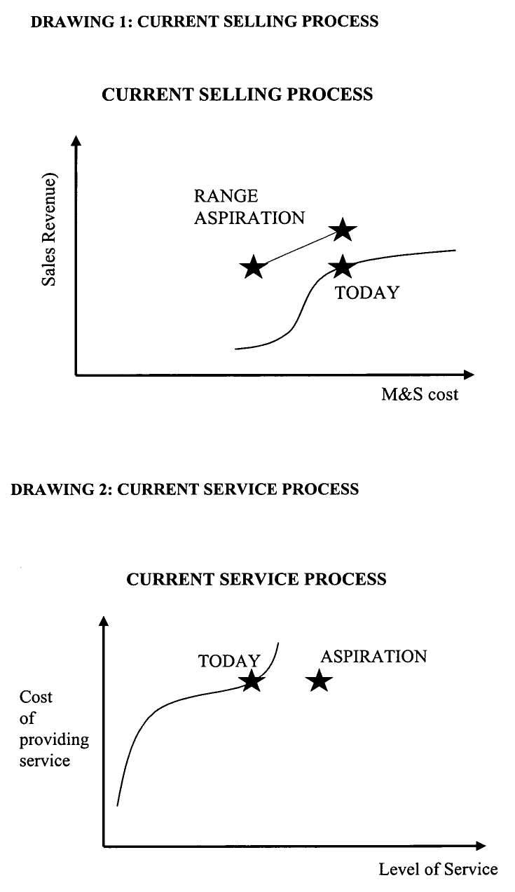

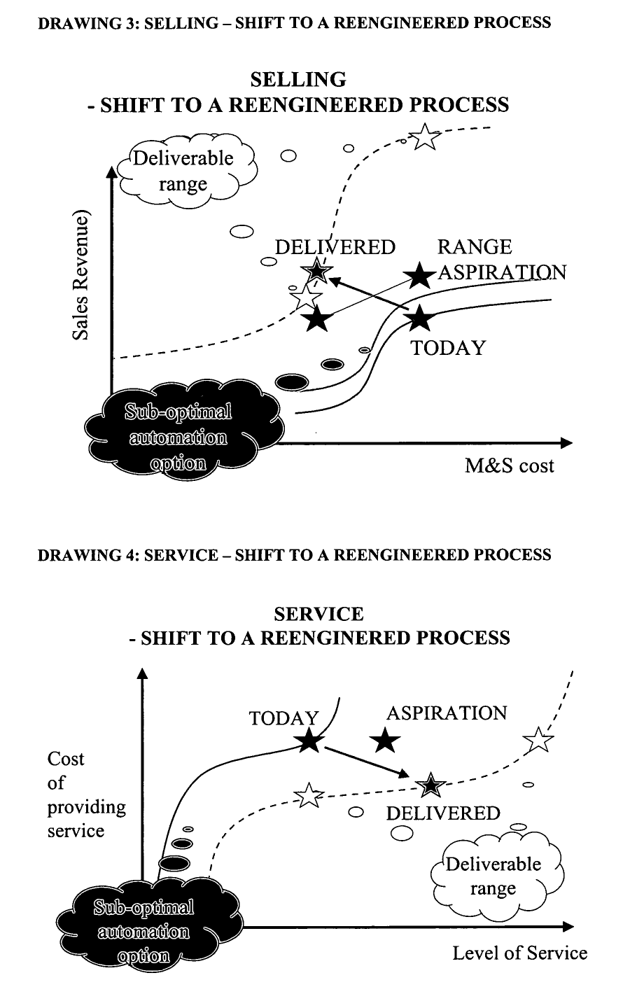

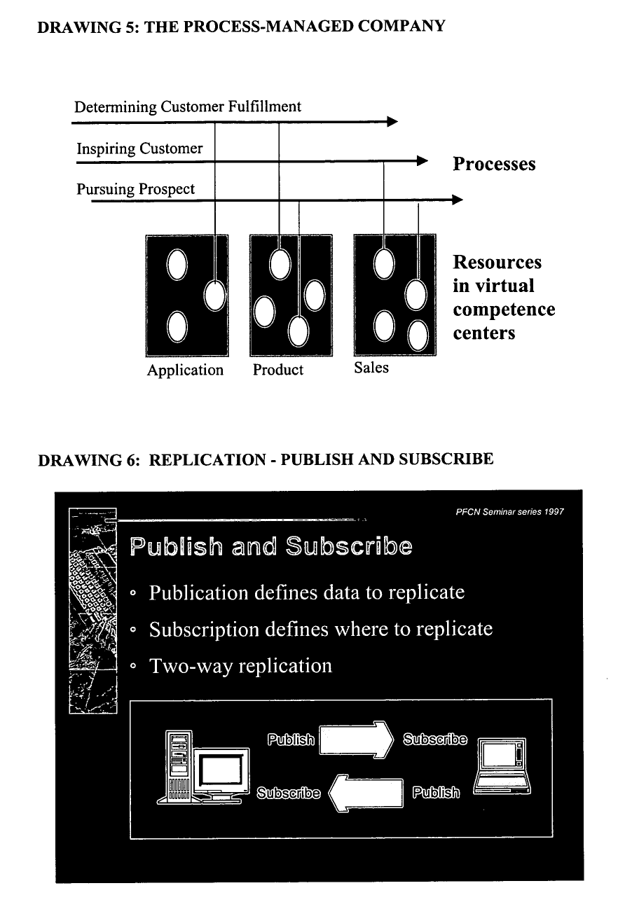

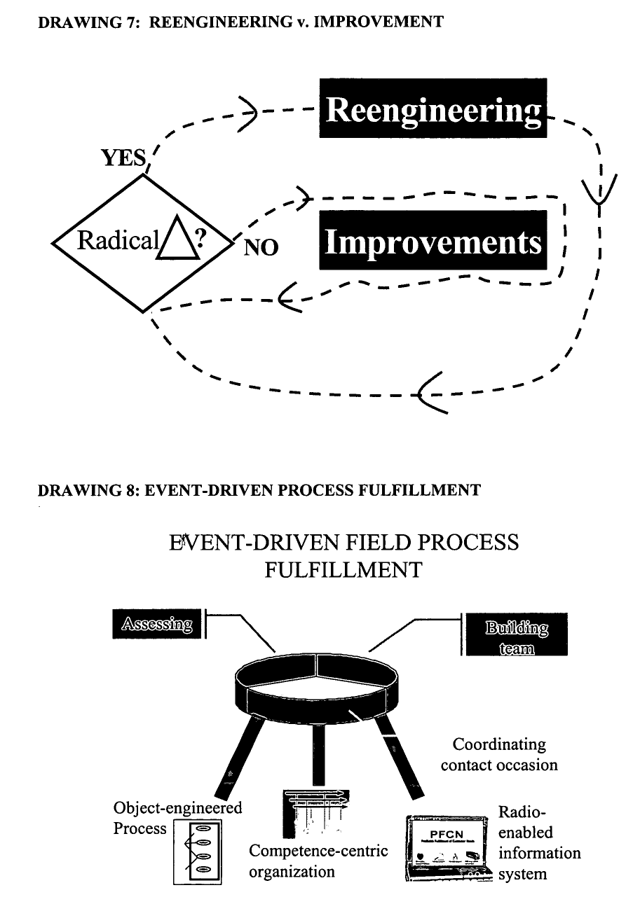

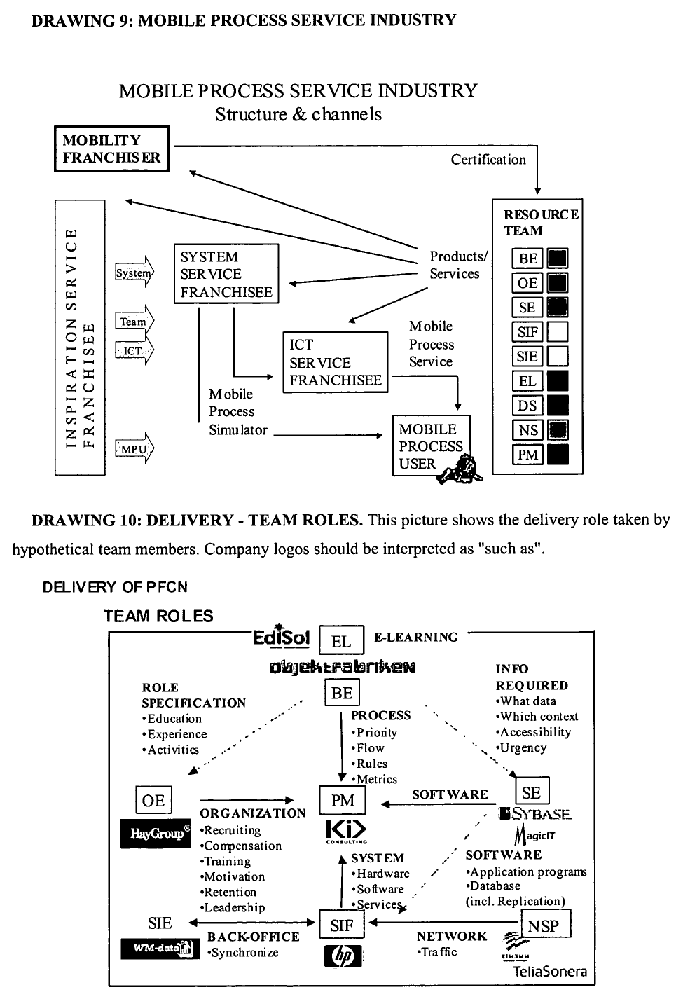

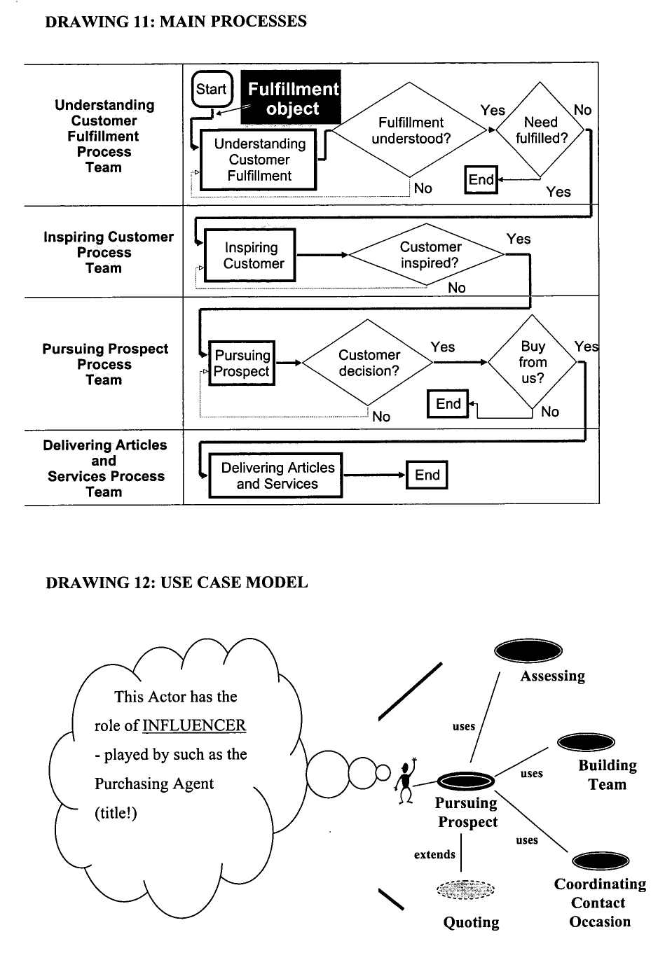

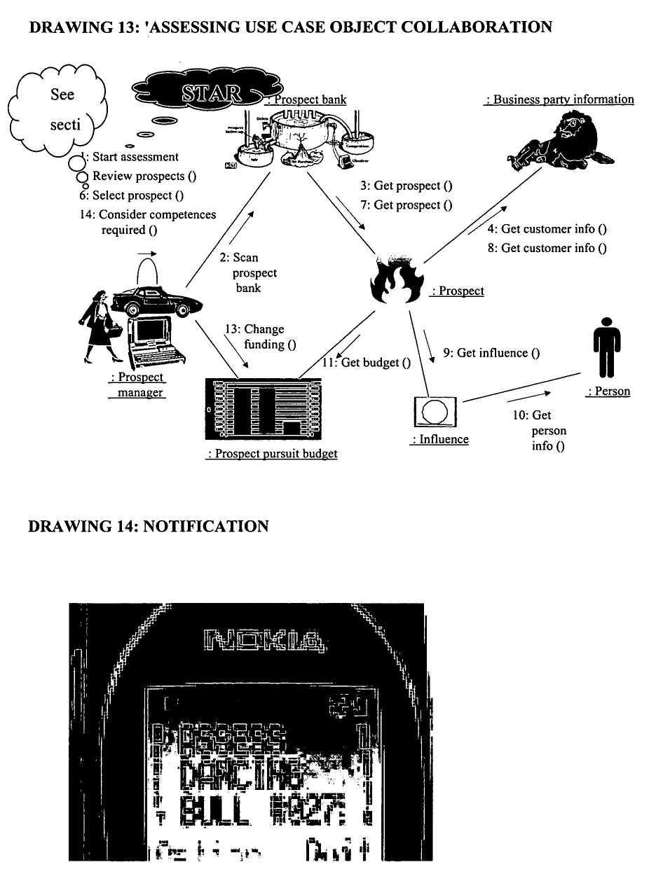

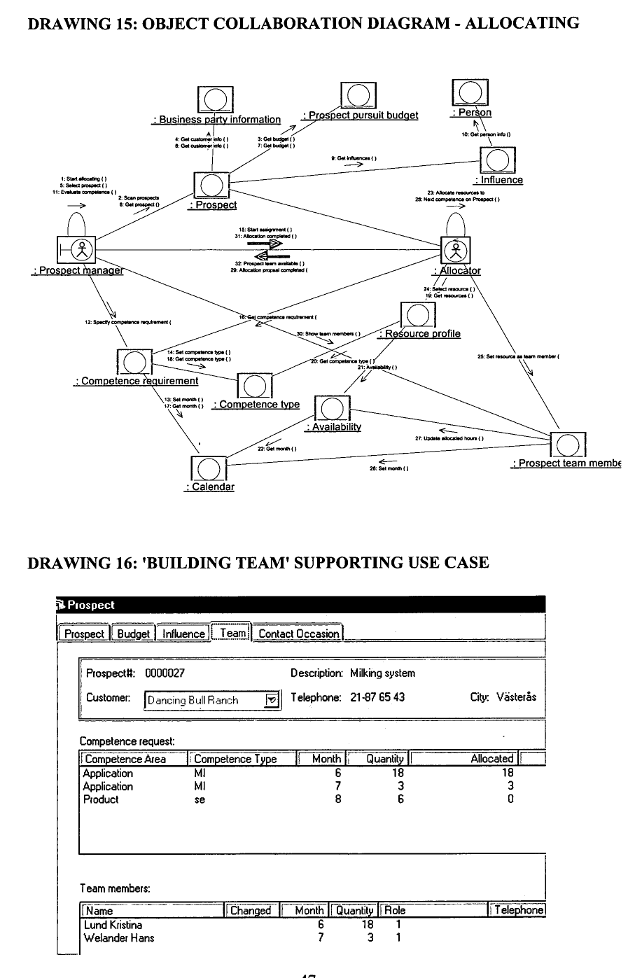

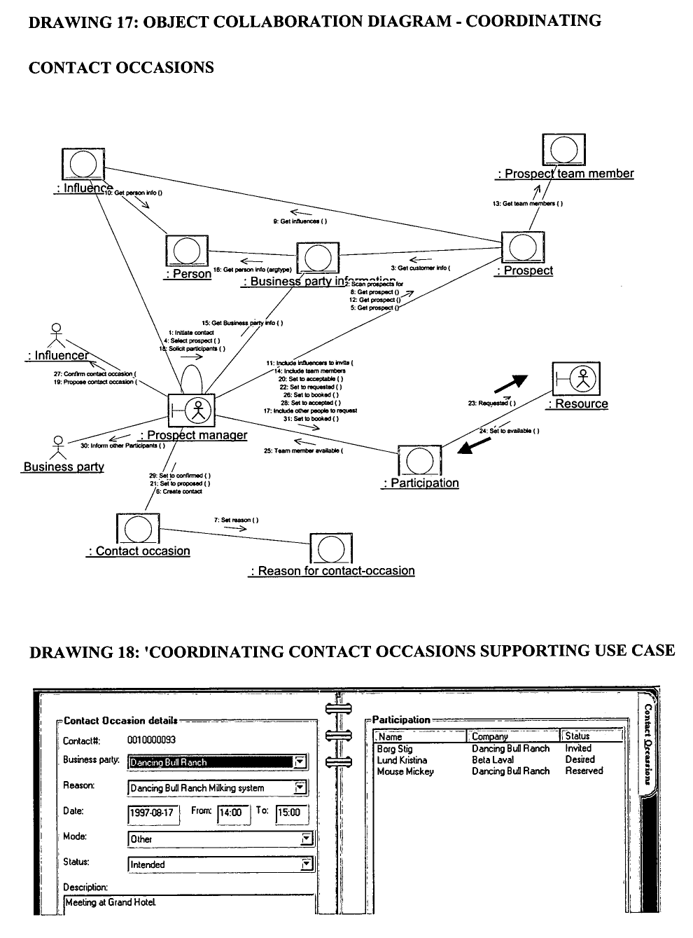

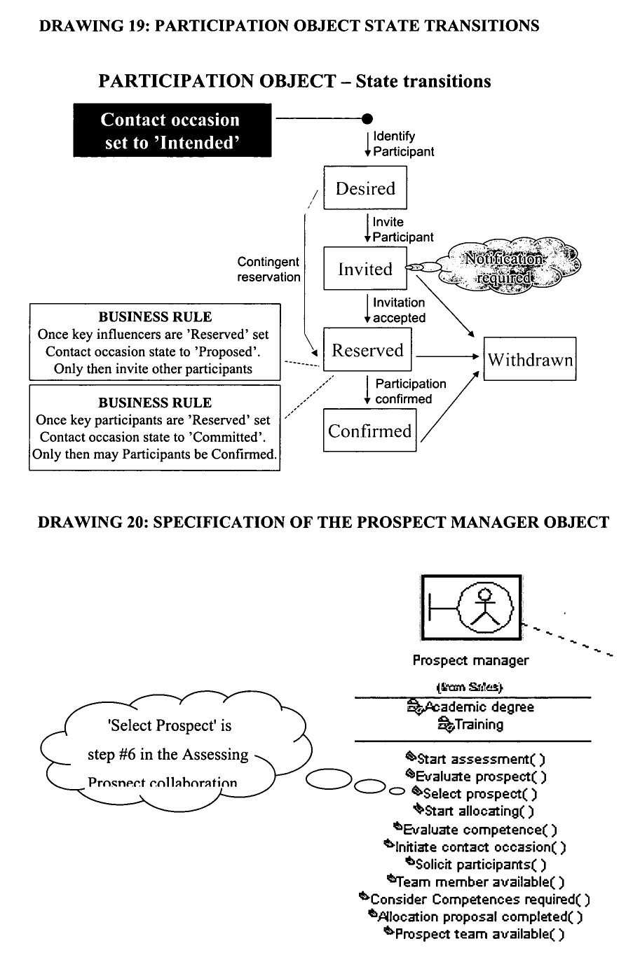

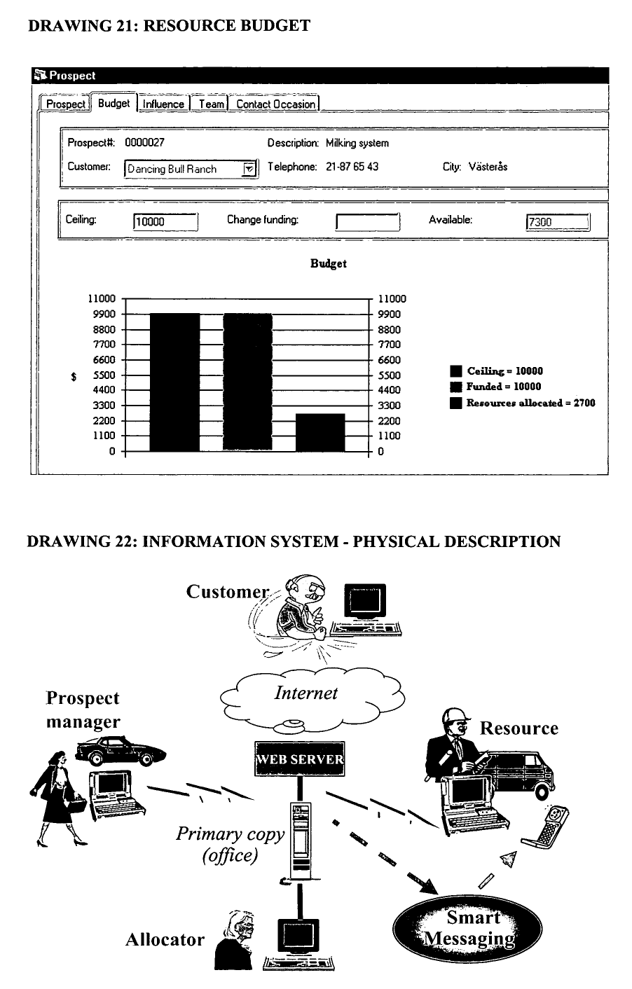

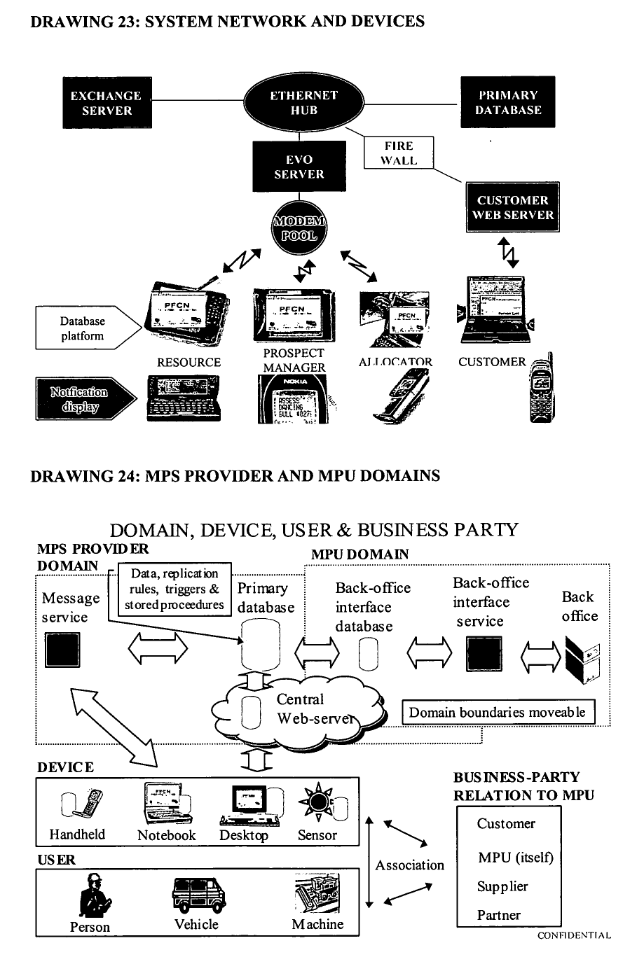

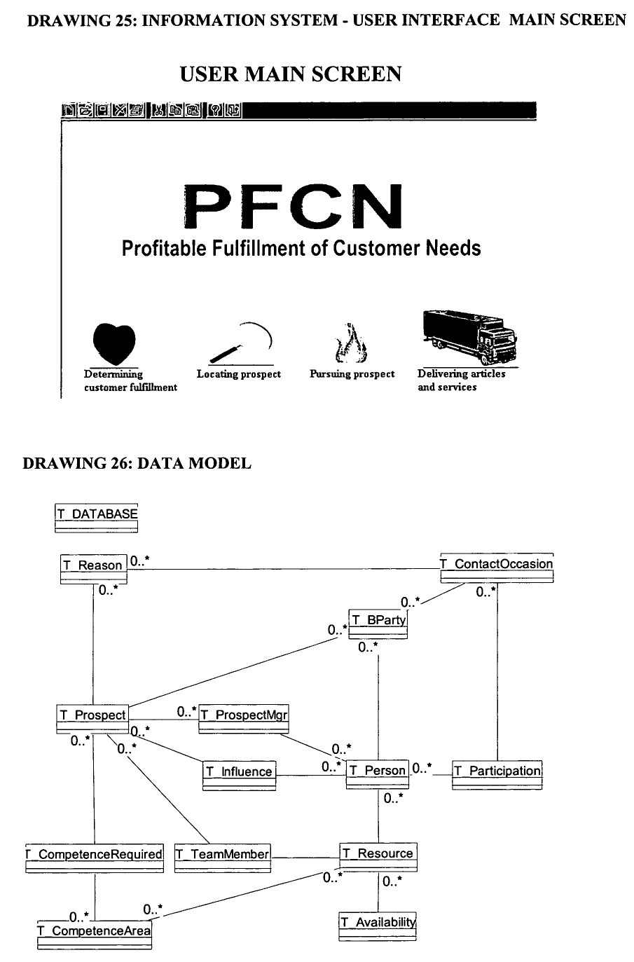

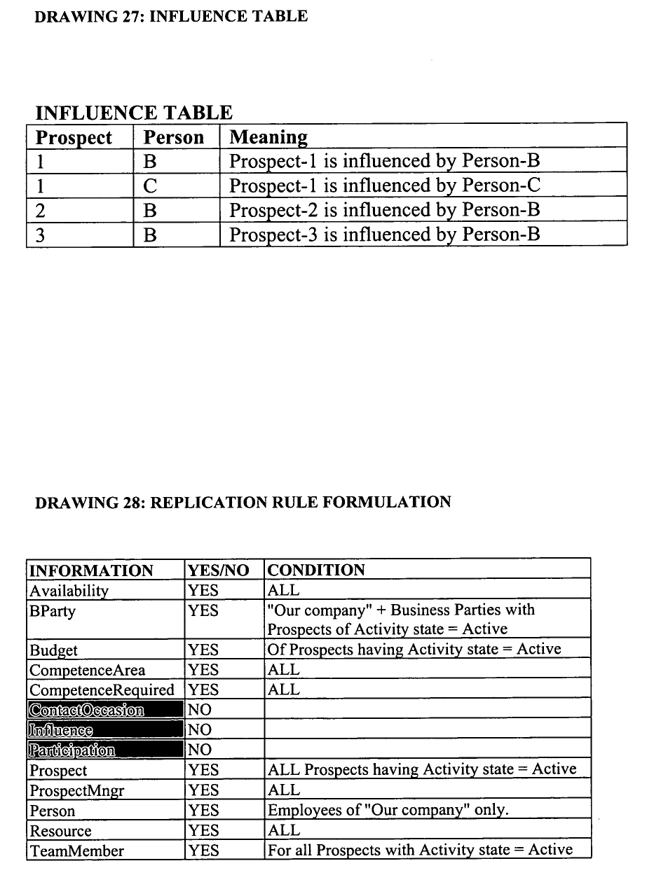

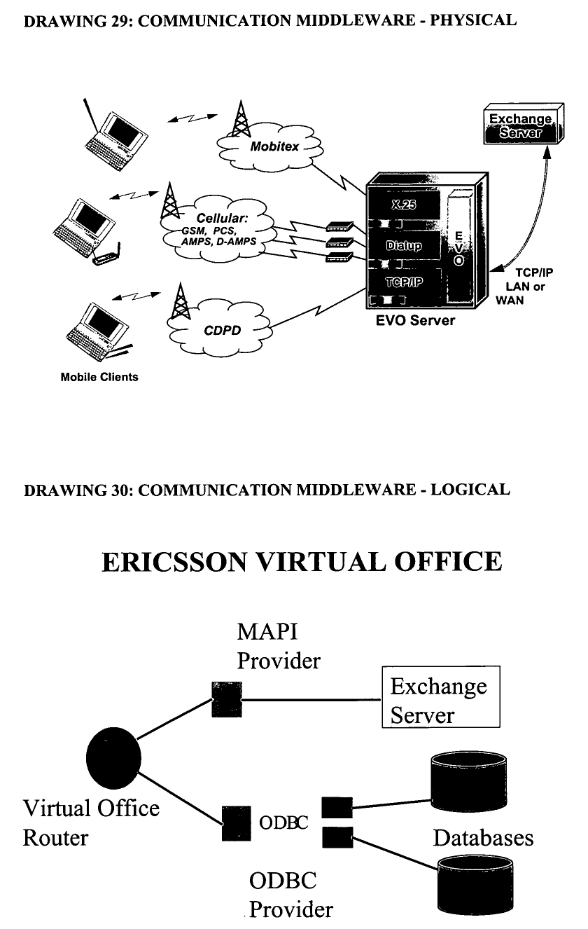

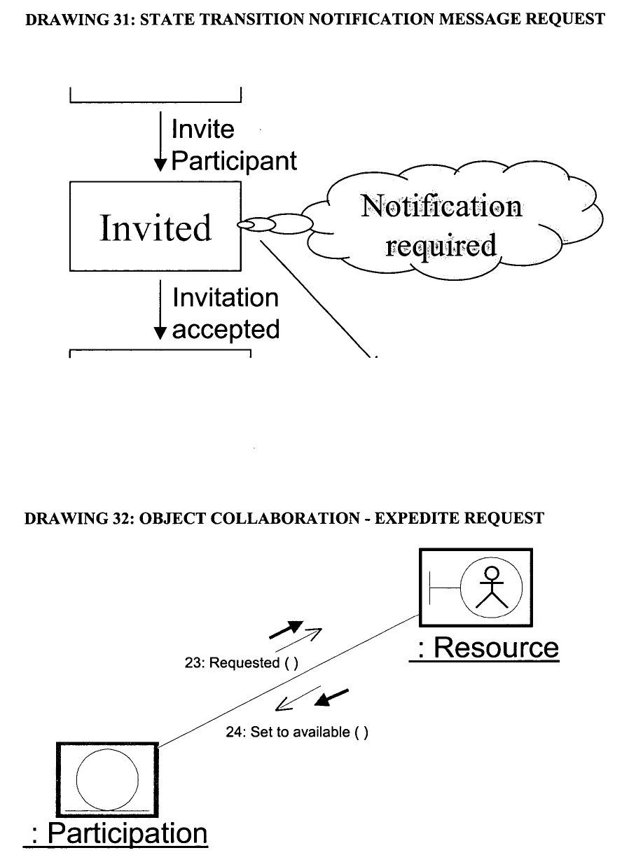

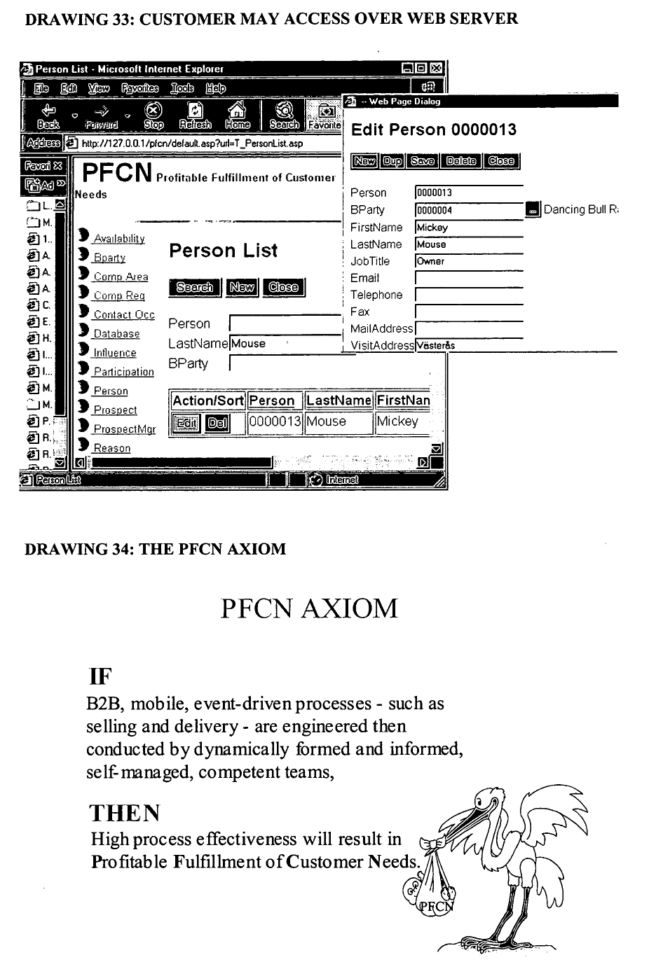

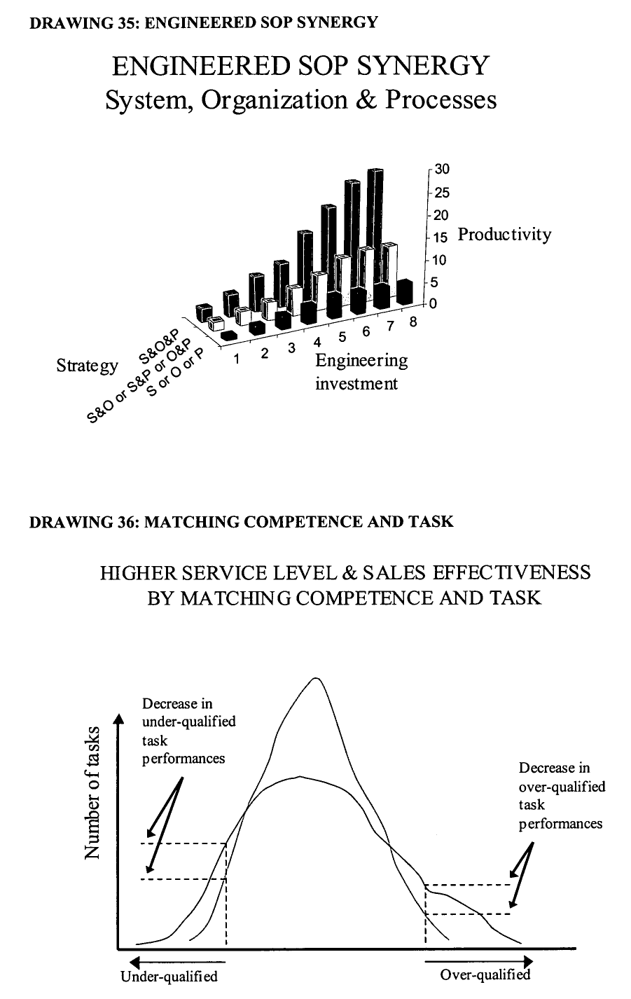

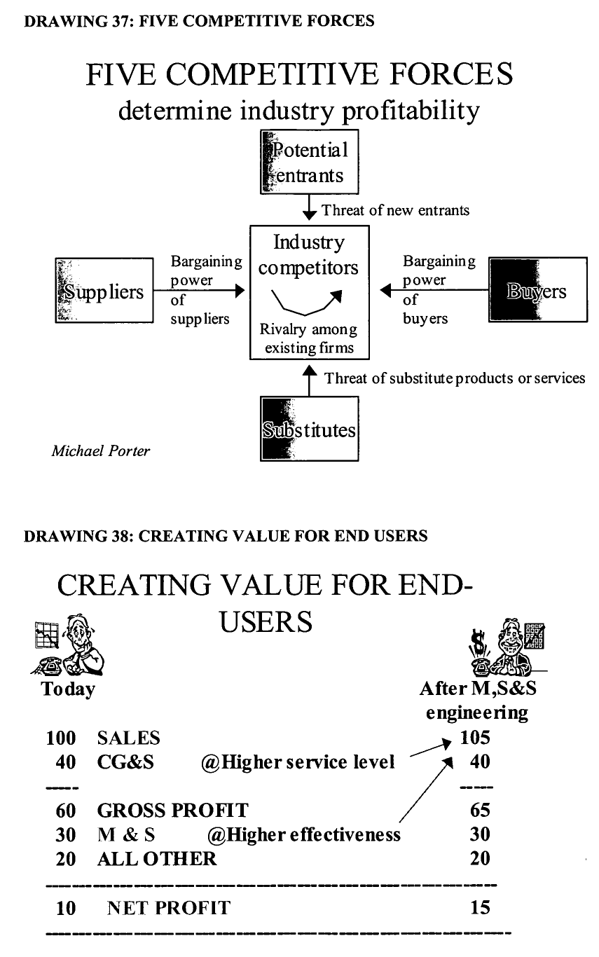

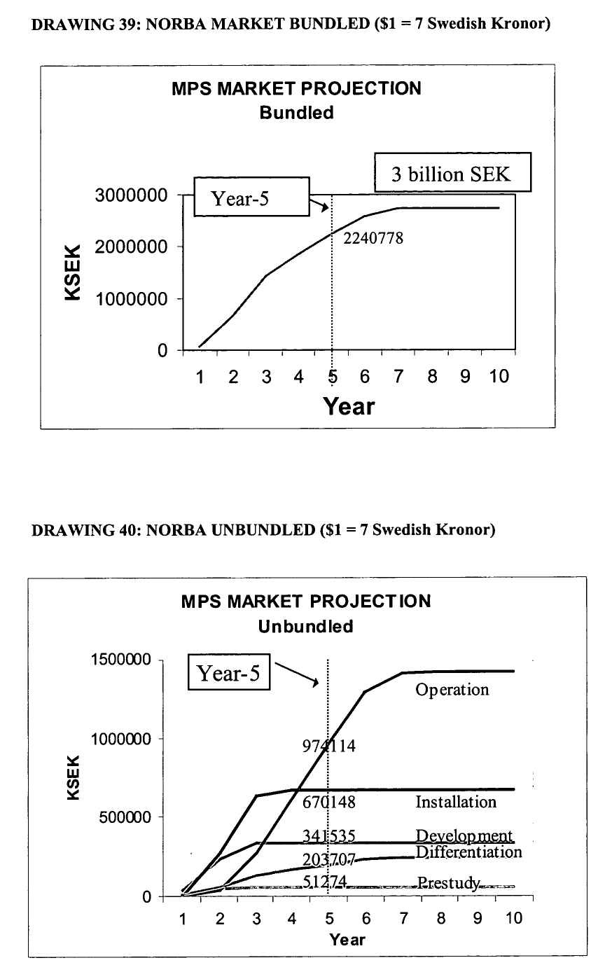

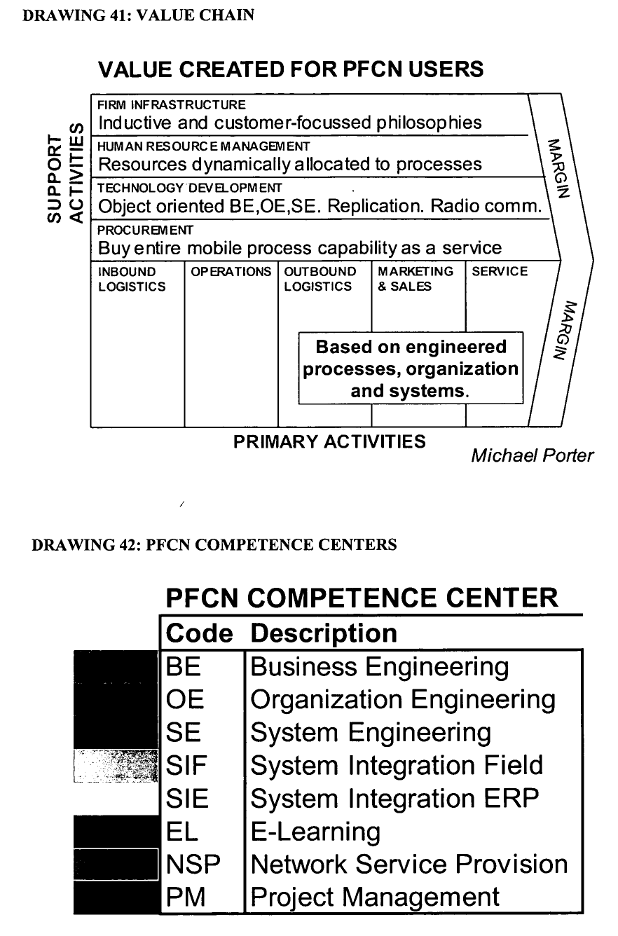

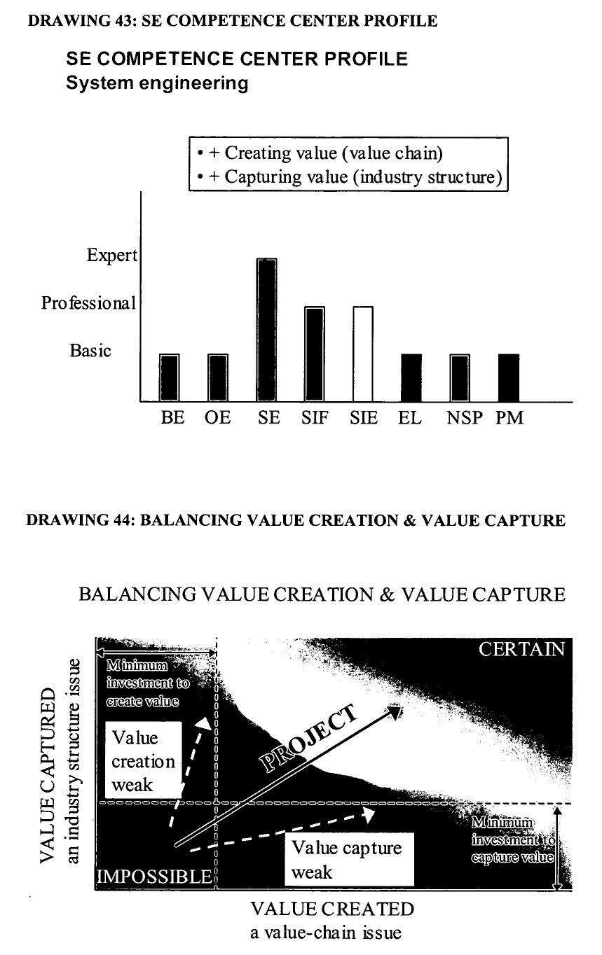

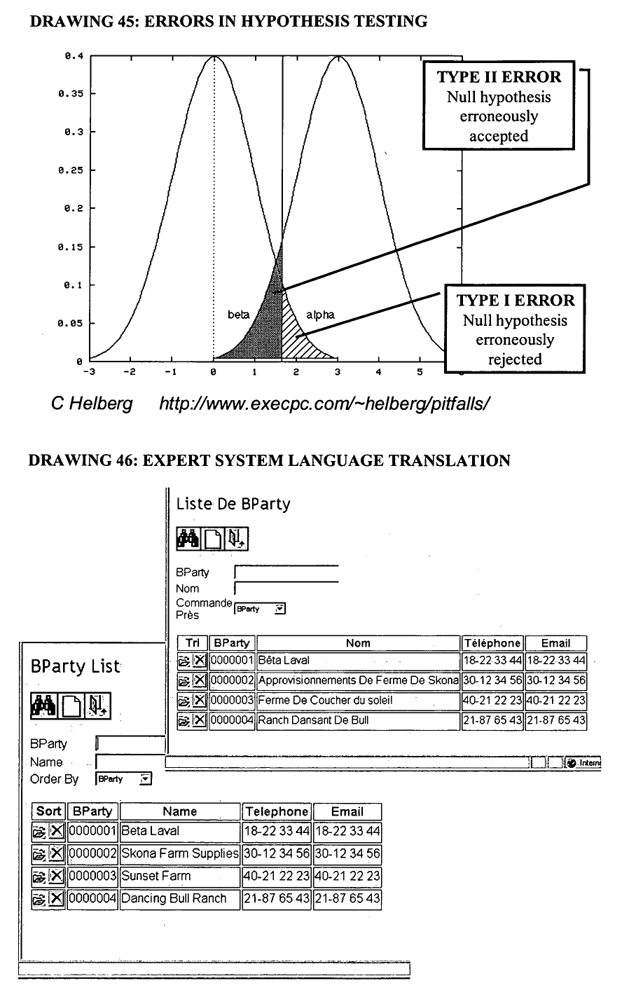

### E. BACKGROUND OF THE INVENTION

E.1 Field of Invention

The invention concerns the reengineering of event-driven, field business processes (for example sales, or delivery of articles and/or services at customer sites), enabled by teams assembled within a competence-centric organization that is, in turn, enabled by an information system exploiting data distribution over radio.

Of particular interest is the deployment as a Mobile Process Service—with emphasis on ‘process’ rather than ‘product’ or ‘application’. Deployment can be worldwide due to advances in ICT (information communication technology).

E.2 Background Art and Assessment Thereof

E.2.1 Theoretical Background

E.2.1.1 Relationship Between Effort and Result

The generic S-curve nature of the relationship between effort and result is well established.

In the ‘selling process’ case, for example, the aspiration is to optimize the combination of sales revenue and M&S (marketing and selling) costs so as to maximize profit. It's easy to show arithmetically how modest increases in sales revenues and/or slight reductions in M&S costs have high impact on net profit.

See Drawing 38: Creating Value for End-Users

Choosing the best point (TODAY) on the current (red) curve is done somewhat intuitively today. It's natural to increase resources (like adding another salesman) if expected additional gross profit generated exceeds the extra selling cost. Increasing M&S costs has little or no effect on Sales revenue once on the plateau.

See Drawing 1: Current Selling Process

In the ‘service process’ case companies aspire to providing the highest affordable level of service and try to improve service level both in response time and in delivered quality. Any attempt to increase TODAY's level of service increases cost exponentially unless the service process is re-engineered.

See Drawing 2: Current Service Process

Due to economies of scale there is a range in which sales-revenues are highly responsive to applied M&S resources (costs) and in which levels of service can be economically improved (red curve). However, in both the selling and service cases both curves hit an asymptote—sales revenue does not respond to further M&S costs and attempts to deliver higher service causes exponential increases in cost of providing that service. These ‘plateaus’ are due to diminishing returns.

Most companies are at a point nearing the plateau—otherwise they would simply move along the curve until they do reach the plateau (red star on diagrams)—in other words they would just do ‘more of the same’ as long as return is greater than cost.

See Drawing 3: Selling—Shift to a Reengineered Process

See Drawing 4: Service—Shift to a Reengineered Process

Modest gains might be made by automation of the existing processes. But the ‘automated process’ (orange) curve is identical in shape to today's more manual process—just displaced. Savings from pure automation are often not worth the cost of automating.

Significant sales-revenue increases and level-of-service improvements, respectively, require reengineering the processes. Then new curves of a different shape emerge (green) in which increasing sales-revenue and level-of-service occur in an economical manner.

E.2.1.2 Processes Conducted by Teams

Sales and service processes are event-driven because of the unpredictable behavior of buying organizations and competitors (for sales) and machines (for delivery of service). Therefore it seems reasonable to consider possible ways of responding quickly to these events with appropriate competence. Thus, it is axiomatic (self-evident) that:

IF
event-driven processes, such as selling and service, are conducted by dynamically formed and informed, self-managed, customer focused teams, consisting of expert team members as appropriate to the progression of the process

THEN
sales revenues achieved (at a particular M&S cost level) and the cost-of-providing-service (at a particular service-level) can be dramatically improved.

For event-driven field processes particularly, there is still a need to find more effective and efficient ways to achieve 1:1 (one person to one person), 1:N (one person to a team), N: 1 (a team to one person) and N:N (team to a team) interactions.

Such team: team interactions are desirable within and between the inbound (such as buyer) and outbound (such as seller) process participants. Analogous to a football game, both teams must keep their eye-on-the-ball, being prepared at all times that the ball be passed to them to apply their particular skill or to respond to action by the other team.

E.2.2 The State-of-the-Art

E.2.2.1 Background Art—the Productivity Paradox of Information Technology.

Modern communication technology has resulted in exponential growth of information distribution from the ‘hubs’ of centralized organizations but, on average, the information distributed has low added value beyond quick dispatching. Centralization is also contrary to the way people like to work. The high cost, low speed and the incomplete radio network coverage (except in the cities) are facts that will not go away soon. Productivity corresponding to exponentially increasing information communication traffic is thus not being realized. This is part of the long-standing ‘Productivity Paradox of Information Technology’.

E. 2.2.2 Background Art—, Object-Oriented Business Process Engineering

Background art includes the availability (for at least five years) of tools to model business processes in an object-oriented manner (such as Rational Rose from the Rational Software company). Business objects, including objects that represent worker role in processes, are identified by a so-called ‘Use-case’ approach. These objects are later mirrored electronically in a supporting information system.

A software tool capable of converting an object-oriented business-engineering model to a system model was released to the market only in 1998. Therefore we believe that there are few published cases in which systems have been developed as a waterfall from business model to system model to working system and there are certainly no cases of systems created in such a manner that are an integral part of offerings of entire mobile process service (MPS) delivered over ICT.

E. 2.2.3 Background Art—Competence-Centric Organization

The literature includes rather vague references to Competence Centers (Beyond Reengineering—Champy). However, there are very few concrete adoptions—for reasons that include the unwillingness to give up ‘turf’ (hierarchical organizations) and the many other human factors such as recruitment, education, motivation and compensation of teams.

See Drawing 5: the Process-Managed Company

The need for such organizations applies to, for example, consultative selling processes where there is discussion of need/solution between seller/buyer. In the delivery processes, especially delivery of engineering service that achieve the repair/maintenance of increasingly sophisticated equipment, such organizations are also needed.

Hierarchical, departmental organization is still the norm in most companies. This results in allocation of tasks to resources from smaller, and more generally (rather than specially) qualified units. Furthermore, a person's competence (education/training/experience) is still applied repetitively to few (usually one) processes (such as selling) rather than being spread over several processes.

In contrast, a competence-centric organization has qualified (educated, trained and experienced) personnel in (virtual) competence centers. An engineer (for example) may be assigned to activities within development, production or marketing/sales processes when/where required as the process progresses. Today such organizations rarely exist because the department (marketing, sales, development, production) ‘owns’ the resource.

See Drawing 36: Matching Competence and Task

E.2.2.4 Background Art—Access to Data Stored at a Central Site

Wire-line can collect and deliver data as far as the radio base-station. From there it must travel by radio to mobile people. Today communication by radio is still slow, expensive (typically up to 25 cents/minute during business hours). Good radio coverage is limited to cities—and there circuits are becoming overloaded. Wide coverage (especially internationally), convenient, fast, low cost direct radio access to data stored at a central site is still several years away. The development of good coverage has been handicapped by the recent auction of operating licenses by governments at high prices making subsequent investment in more base-stations (needed to give better coverage) a severe financial strain for operators.

E. 2.2.5 Background Art—Data Replication

Data can be replicated from Data Base Management Systems (DBMS) based on rules that identify which rows/columns of data tables shall be exchanged between stations (for example using Adaptive Server DBMS from Sybase). However, the rules for replication are still primitive—based on intuitive understanding of data requirement. This means that data delivered over radio is far from optimized and has low average value-added.

See Drawing 6: Replication—Publish and Subscribe

E.2.2.6 Background Art—Ultra-Lite DBMS

Recently DBMSs with minute ‘finger-print’ have appeared (such as from Sybase). These can carry a database on palmtop (Psion) and mobile phone. New operating systems (Windows CE from Microsoft and EPOC from Symbian) capable of working with these DBMSs are available. Present applications are limited to storing small personal databases and two-way paging and certainly do not include the orchestration of self-managed teams.

E.2.2.7 Background Art—DBMS Triggers

Some DBMSs (data base management systems) have the capability of creating notification messages when the ‘state’ of an object changes. This is achieved by using ‘triggers’. Such capability is hardly exploited today because the critical state-transitions have not been defined in the processes therefore what is notified to whom is ad hoc.

E.2.2.8 Background Art—Simple Notification

The most advanced combination of appropriate notification to the appropriate person in effect today is a short message sent to a mobile telephone to advise the recipient that there is a waiting E-Mail—the title of the E-Mail may also be displayed. But the E-Mail content itself is generally very unstructured, it is sent manually on a 1:1 or 1:N basis, is expensive to retrieve over radio and the E-Mail becomes yet another fragment in the unorganized in-box of the recipient.

### F. BRIEF SUMMARY OF THE INVENTION

### F.1 PFCN—Profitable Fulfillment of Customer Needs

If customer needs are not fulfilled (satisfied) then there is no way in which vendors can be profitable. However, it can happen that customer needs are fulfilled but, nevertheless, the vendors fail to capture enough of created value for they themselves to be profitable.

The acronym PFCN, Profitable Fulfilment of Customer Needs, the philosophy underlying the invention, reflects the intention for win-win. This requires that the vendor:
a) creates value for the customer (a Value Chain issue), AND
b) captures a fair share of that value (an Industry Structure issue).
Thus, projects for customer clients must strike a balance between creation and capture of value. The invention does exactly that—it creates value in a customer team environment, but also assures that the value within the vendor team will be captured in an equitable way for, and between, the vendors (that also work as a team!).

See Drawing 44: Balancing Value Creation & Value Capture

### F.2 The Invention is Recognition, Followed by Realization, of the PFCN Axiom!

F.2.1 Recognition of the PFCN Axiom by Inductive Thinking

Traditional business education is based on deductive thinking. Deductive thinking starts with a problem and reasons about different ways to solve the problem (the pay-off matrix). Such an approach is analogous to goal achievement (solving the problem) by back-chaining logic as applied in some expert systems:
The problem in our case is to make event-driven B2B mobile processes more effective and efficient
Such effectiveness and efficiency could be achieved if business process could, somehow, be readily reengineered.
Such process reengineering could be achieved if appropriate organization changes could, somehow, be implemented.
Such organization changes could be implemented if appropriate systems to support those changes could, somehow, be developed.

The invention breakthrough was the sudden recognition of the organizational and process effects that occurred when isolated new technology implementations, originally intended as automations of traditional processes, were made. For example, automation of complex pricing calculations done on notebook PCs (a technology implementation) meant that the billing process could now be done at the customer site (a process change); the central billing department thus disappeared (an organization change).

This led to the formulation of the PFCN hypothesis in which synergies were suspected—but not yet rigorously proven. This led to pressure to test the hypothesis, but because of the recent dot-com bubble experience there was extreme resistance to moving ahead as if the hypothesis was true. Even scientific explanation of the risks of missing the next big idea because of inaction failed to provoke modest testing of the hypothesis.

See Drawing 45: Errors in Hypothesis Testing

However, it soon became self-evident to experienced B2B process observers that the organizational and process effects could be harnessed to yield dramatic changes in effectiveness and efficiency but that this must be done in a structured way—by business process engineering. The PFCN hypothesis was therefore upgraded—leapfrogging the traditional escalation from hypothesis to theory, and hence to law, and jumping directly to axiom status. If the positive effect of actions is obvious it should be done! This is exactly what Lucy Kellaway recommended in her recent article in Financial Times. “I'd like to offer academics considering further studies a tip. If they already know the answer to a question, proving it statistically is not time well spent. Which leaves one wondering how it is possible to be so very clever and so fantastically stupid at the same time.”

See Drawing 34: the PFCN Axiom

The PFCN axiom was thus recognized by inductive thinking—understanding that new technical capabilities can solve persisting, and perhaps accepted, problems:
New technology, such as the instantaneous creation of distributed databases invoking data over radio, means that new systems to be built.
Such systems enable self-managed team organization to be sustained in which teams are dynamically formed and informed.
Such team-oriented organization enables processes to be reengineered in a manner that creates more value through greater effectiveness and efficiency.

The recognition of the axiomatic nature of the PFCN approach is, in fact, due to the well-established fact that ‘need is based on an understanding of what is possible’. Since it is now technically possible to satisfy all the prerequisites of the PFCN axiom through the synergistic combination of systems, organization and processes why not do it?

See Drawing 35: Engineered SOP Synergy

Thus the invention has been conceived by inductive thinking but, once understood, has been implemented by traditional deductive thinking—as we will now describe . . . .

F.2.2 Realization of the PFCN axiom by deductive thinking

The invention exploits the understanding that an entire mobile process service (MPS) can be realized by the deductive combination of object-oriented business process reengineering, competence-centric organization and object-oriented system development with final software generation by RAD (rapid application development). Global deployment of reengineered processes with ICT is the icing on the cake.

The invention is characterized by conducting event-driven processes with teams dynamically formed and dissolved by the requisition of members from virtual competence centers using an information system whereby each team member is notified of a change of state that requires activity and that exactly the right information required to execute that activity—as indicated by a business object collaboration model (another new technology)—is physically communicated to local, distributed databases by replication over radio.

The synergistic combination of isolated new Information system, isolated new Organization ideas and isolated new Business Processes modeling capability is achieved in the following way:

F.2.2.1 Information System

High integrity distributed data bases (on portable devices called-B) are maintained by replication and asynchronous (message) communication to a remote, primary, database (called-A), including one or more stations operating over radio, often using middle-ware that enables transparent multi-network (e.g. circuit/packet switched) data transport.

Automated message notifications of critical changes of state are made over pocket (or smaller) communication devices (called-C) such as mobile phones and/or pagers and/or communicators. When a user has both a distributed database (on device called-B) and a pocket device (called-C) then there may be one- or two-way wire or wireless interaction between A and C and/or between B and C by asynchronous communication.

An information system of this nature synergistically facilitates the following organization:

F.2.2.2 Organization

Virtual, dynamically formed and dissolved, empowered customer-focused teams that conduct marketing or sales or service processes. Teams are formed by requisition of resources from virtual competence centers to manage the state-transitions of key objects.

An organization of this nature synergistically facilitates the following business processes:

F. 2.2.3 Business Processes

Event-driven processes, wherein activities are conducted at remote sites (such as at customer premises), often engineered by object-oriented modeling then conveyed to organization architects and information system builders as descriptions of processes in particular:
1. assessment of the continuously changing (event-driven) situation to determine the value of the resource that should justifiably be applied to the process,
2. formation of the team (by requisitioning resources from competence centers),
3. coordination of contact occasions (in which people and/or equipment, and/or sites such as meeting rooms participate).

### F.3 ADVANTAGEOUS EFFECTS OF THE INVENTION

### F.3.1 WHY Does the Invention Give a ‘Result of Value’?

The reason for results of value can be traced to value chain effects—in particular:
HR Management in the ‘support activities’ area,
outbound logistics for vendors and the mirror-image inbound activities for customers, and
marketing/selling.

See Drawing 41: Value Chain

### F.3.2 FOR WHOM Does the Invention Give a ‘Result of Value?

F.3.2.1 Outbound Process Beneficiary

The organization conducting the outbound process—such as selling or performing the service (Dr. Michael Porter terminology) benefits from the following added values:
If an organization conducts the marketing/sales or service process at lower cost (efficiency) this leads to higher profit to that organization.
Alternatively the lower cost may enable a lower price to be offered resulting in being more competitive (effectiveness).
And/or the result may be better (effectiveness) yielding more sales or, in the case of service, a higher quality repair/maintenance job thus improving the reputation of the party conducting the outbound process—and enable charging a higher price.
   F.3.2.2 Inbound Process Beneficiary

The organization conducting the inbound process, such as buying, or being the owner/user of the equipment being serviced, also gain value in the form of:
reducing time/cost incurred in reaching the buying decision (efficiency), and/or
making a better choice regarding what to buy (effectiveness), and/or
getting a prompt (efficiency) higher quality (effectiveness) service repair/maintenance job done.
   F. 3.2.3 Personal Satisfaction Beneficiary

All individuals involved in the superior processes gain value. One source of such value is when the employee work satisfaction is increased. For example—engagement in tasks that are self-planned and at/near the upper limit of competence leads to job satisfaction (value to employee) and consequently lower employee turnover (value to employer).

### F.3.3 What is The Magnitude of The Benefits of The Invention?

Capture of created value (due to SOP synergy) depends on industry structure.

See Drawing 37: Five Competitive Forces

One option for industry structure is a franchise arrangement in which a FranchisER appoints three types of FranchisEE. This particular franchise structure will be one of the invention claims (see later) because it is the means of:
conducting both marketing/selling and delivery processes of the proposed mobile process service (MPS) to create value, and
protecting the capture of a fair share of the value created for the ICT franchisee—without such protection it is likely that the ICT service would be relegated to commodity status (this is a dilemma for today's telecom industry).

See Drawing 9: Mobile Process Service Industry

F. 3.3.1 Benefit Magnitude for Mobile Process Service End-Users (MPUs)

See Drawing 38: Creating Value for End Users

In this example any company that conducts mobile processes will benefit by using the invented mobile process service because of increased effectiveness of both their marketing/selling and delivery processes. Their customers will be more satisfied with the mobile process user's new processes and thus will buy more from such vendors (or buy the same volume at a higher price). A modest 5% increase in sales results in a 50% increase in profit for the mobile process user.

F.3.3.2 Benefit Magnitude for Vendors of the Mobile Process Service

The current estimate for the mobile process service market in the NORBA countries (consisting of Denmark, Finland, Iceland, Norway, Sweden and the so-called ‘Baltic States’ of the previous USSR) is over two billion Swedish Kronor (about three hundred million US$) in the fifth year. This could be extrapolated to six billion US$ worldwide.

See Drawing 39: Norba Bundled ($1=7Swedish Kronor)

Exactly how the revenue might be divided between the vendors also depends on industry structure. The example chosen for illustration shows the split between the proposed SYSTEM resource team-members (Prestudy and Development) and the ICT team-members (Operation). It might be that there will be sufficient revenue generated by what is called ‘Differentiation’ (due mainly to synergy between team-resource expertises) that the Franchiser and Franchisees can live on this. The resource team-members can reap unusually high margins as resource team-members and will not be tempted to compete as ‘new entrants’ to the franchisee's position in the channel (an industry structure insight).

See Drawing 40: Norba Unbundled ($1=7 Swedish Kronor)

### G. BRIEF DESCRIPTION OF THE VIEWS OF THE DRAWING

DRAWING 1: CURRENT SELLING PROCESS 40

DRAWING 2: CURRENT SERVICE PROCESS 40

DRAWING 3: SELLING—SHIFT TO A REENGINEERED PROCESS 41

DRAWING 4: SERVICE—SHIFT TO A REENGINEERED PROCESS 41

DRAWING 5: THE PROCESS-MANAGED COMPANY 42

DRAWING 6: REPLICATION—PUBLISH AND SUBSCRIBE 42

DRAWING 7: REENGINEERING v. IMPROVEMENT 43

DRAWING 8: EVENT-DRIVEN PROCESS FULFILLMENT 43

DRAWING 9: MOBILE PROCESS SERVICE INDUSTRY 44

DRAWING 10: DELIVERY—TEAM ROLES. This picture shows the delivery role taken by hypothetical team members. Company logos should be interpreted as “such as”. 44

DRAWING 11: MAIN PROCESSES 45

DRAWING 12: USE CASE MODEL 45

DRAWING 13: ‘ASSESSING USE CASE OBJECT COLLABORATION 46

DRAWING 14: NOTIFICATION 46

DRAWING 15: OBJECT COLLABORATION DIAGRAM—ALLOCATING 47

DRAWING 16: ‘BUILDING TEAM’ SUPPORTING USE CASE 47

DRAWING 17: OBJECT COLLABORATION DIAGRAM—COORDINATING 48

DRAWING 18: ‘COORDINATING CONTACT OCCASIONS SUPPORTING USE CASE 48

DRAWING 19: PARTICIPATION OBJECT STATE TRANSITIONS 49

DRAWING 20: SPECIFICATION OF THE PROSPECT MANAGER OBJECT 49

DRAWING 21: RESOURCE BUDGET 50

DRAWING 22: INFORMATION SYSTEM—PHYSICAL DESCRIPTION 50

DRAWING 23: SYSTEM NETWORK AND DEVICES 51

DRAWING 24: MPS PROVIDER AND MPU DOMAINS 51

DRAWING 25: INFORMATION SYSTEM—USER INTERFACE MAIN SCREEN 52

DRAWING 26: DATA MODEL 52

DRAWING 27: INFLUENCE TABLE 53

DRAWING 28: REPLICATION RULE FORMULATION 53

DRAWING 29: COMMUNICATION MIDDLEWARE—PHYSICAL 54

DRAWING 30: COMMUNICATION MIDDLEWARE—LOGICAL 54

DRAWING 31: STATE TRANSITION NOTIFICATION MESSAGE REQUEST 55

DRAWING 32: OBJECT COLLABORATION—EXPEDITE REQUEST 55

DRAWING 33: CUSTOMER MAY ACCESS OVER WEB SERVER 56

DRAWING 34: THE PFCN AXIOM 56

DRAWING 35: ENGINEERED SOP SYNERGY 57

DRAWING 36: MATCHING COMPETENCE AND TASK 57

DRAWING 37: FIVE COMPETITIVE FORCES 58

DRAWING 38: CREATING VALUE FOR END USERS 58

DRAWING 39: NORBA MARKET BUNDLED ($1=7 Swedish Kronor) 59

DRAWING 40: NORBA UNBUNDLED ($1=7 Swedish Kronor) 59

DRAWING 41: VALUE CHAIN 60

DRAWING 42: PFCN COMPETENCE CENTERS 60

DRAWING 43: SE COMPETENCE CENTER PROFILE 61

DRAWING 44: BALANCING VALUE CREATION & VALUE CAPTURE 61

DRAWING 45: ERRORS IN HYPOTHESIS TESTING 62

DRAWING 46: EXPERT SYSTEM LANGUAGE TRANSLATION 62

### H. DETAILED DESCRIPTION OF THE INVENTION

The invention describes the implementation of a combination of object-engineered process, competence-centric organization and a radio-enabled information system. That combination is then applied through a mobile process service (MPS) to enable field-based teams. This will have a major effect on productivity of the event-driven field processes.

The combination is very multi-discipline and unlikely to occur to a person skilled in just one, or even two, of the necessary three disciplines (process, organization and systems).

A business process is defined by Ivar Jacobssen as ‘a series of activities that delivers a result of value’.

Whether a business process shall be truly reengineered or just ‘improved’ depends on willingness to make fundamental changes in all of:
PROCESS,
ORGANIZATION, and
INFORMATION SYSTEMS.

See Drawing 7: Reengineering V. Improvement

The invention is the result of combining a sub-set from each of these three mutually dependent and synergistic components namely:
Process: object-engineered
Organization: competence-centric, and
Information system: radio-enabled

This combination is then applied not only to main processes but also to the essential supporting process components of event-driven field processes—namely:
assessing (the continuously changing situation),
building team, and
coordinating contact occasions

See Drawing 8: Event-Driven Process Fulfillment

Performance of processes by a hierarchical (dispatch oriented) organization is dispensed with and the object-engineered process, treated as self-managed collaboration (by the team) between business objects, is conducted by co-operation within and between dynamically formed/dissolved teams composed of empowered members drawn from (virtual) competence centers.

Both the organization and process are supported by a radio-enabled information system that provides on-site electronic representation of the progress of the process by mirroring the collaboration between the real objects.

The invention virtually eliminates cost, speed and convenience as hindrances because information is communicated by radio to and from locally stored high integrity databases. This solution is:
low cost for two reasons: a) efficient relational representation of information, and b) field-by-field update by relatively short data packages over radio, furthermore
speed is unimportant because the database is maintained in the background, and access is
convenient because information is always available at the finger-tips (must not be retrieved from a remote central site) and arrives at the user before it will be needed (this is achieved by modeling the required information then rifle-shooting it over radio).
   H.1 Object-Engineered Process

With the exception of one claimed proprietary selling process (in which Understanding Customer Fulfillment will be articulated), the invention applies explicitly to three so-called ‘supporting’ sub-processes that are relevant only when supporting event-driven field processes (such as sales and service). Again, the three supporting sub-processes are:
Assessing (the situation)
Building the team, and
Coordinating contact occasions
   H.2 Competence-Centric Organization

The organization has appropriate Competence Centers to which personnel are recruited and assume a Resource role whenever requisitioned by the Process Leader role and assigned by the Allocator role. Such ‘Competence Centers’ are virtual—not physical.

H.3 Radio-Enabled Information System

The radio-enabled information system has three essential features:
distributed databases, maintained by replication
asynchronous communication over packet-switched radio, and
notification messages.

These foregoing three features are especially powerful when combined. For example, in the following ‘one way of implementing the invention’ section there may be:
cascading replication (for example from a central database, to a field notebook station to a hand-held device carrying the Ultralite DBMS from Sybase) combined with the emerging
Blue-Tooth technology (for communication within short range between a mobile phone and/or palmtop and/or notebook), combined with
   SMS messages for notification.
   H.4 One Way to Carry Out the Invention

NOTE: Some examples are intentionally repetitively described—perhaps once functionally and later in the text technically. The interaction between System, Organization and Process is fundamental and therefore emphasised.

H.4.1 Selection of Example at the Vendor Level

The way in which a mobile resource (working in the field) operates is virtually independent of how the MPS (mobile process system) has been:
sold to the user company,
developed as a system (process, organization and software),
deployed invoking ICT as a combination of data service (DS) and network service (NS).

Nevertheless, that background is shown below because there are claims associated with the manner in which the technical and process thinking permits innovative industry structure and pricing—and vice versa.

H.4.1.1 Mobile Process Service Industry Level

The overall industry structure that will be claimed (see later) as innovative and not obvious has a FRANCHISER and three types of FRANCHISEE (Innovation Service, System Service and ICT Service).

See Drawing 9: Mobile Process Service Industry.

H.4.1.2 Mobility Franchiser (Certification) Level

The MOBILITY FRANCHISER has two operation roles:
Appoint Inspiration-, System- and ICT-Service franchisees
Certify resource Team members

Franchisees may sub-contract only certified resources. This guarantees service quality.

See Drawing 42: PFCN Competence Centers

During certification, the franchiser will assure that Team member resources have the necessary competence profile—at the Basic, Professional or Expert level. For example, the SE resource must be expert in SE, Professional in SIF and Basic in all other areas.

See Drawing 43: SE Competence Center Profile

H.4.1.3 Inspiration Franchise (Customer ‘Inspiring’) Level

The franchiser subcontracts the INSPIRATION FRANCHISEE to conduct the IC (Inspiring Customer) process.

H.4.1.4 System Service Franchisee (Development) Level

The SYSTEM SERVICE FRANCHISEE will sub-contract resource Team members to construct a customized, production quality, PFCN Process Simulator for the mobile process user. This will be achieved by Business Process Engineering, Organization formulation, Software creation as well as system integration in the field devices and to the back-office architecture of the client MPU. The PFCN Process Simulator is the deliverable.

See Drawing 10: Delivery—Team Roles

H.4.1.5 ICT Franchisee (Deployment) Level

The MPU (mobile process user) company has several options:
operate the data service (DS) itself, and/or
ask the ICT franchisee to appoint a DS resource team member, and/or
ask the ICT franchisee to arrange for network services in various countries.
The PFCN architecture is such that the MPU has many options for physical location of the various servers and ‘interface’ databases (the ‘sliding window’ analogy in the drawing). Most important, the ICT service can be arranged so that the ‘System’ designed by the System Franchisee can be deployed worldwide.

See Drawing 24: MPS Provider and MPU Domains

H.4.2 Selection of Example at the Mobile Process User (MPU) Level

The invention is applicable to many event-driven field processes—such as sales, customer service, public emergency services. The PFCN framework has four ‘sub’ main processes (UCF, IC, PP and DAS) from the domain of industrial marketing in which the invention may be carried out. These four sub-processes apply to companies selling capital equipment, consumables or various forms of service ranging from preventive or emergency equipment maintenance to security. We shall show in detail how the invention could be carried out in one of these—the ‘Pursuing Prospect’ (PP) process that pursues an already identified acute, significant, sales opportunity.

See Drawing 11: Main Processes

The foregoing four sub-processes are event-driven to various extents depending on such things as products/services offered, industry and competitive environment. The modern approach is to customize each of these four processes to individual customers.

H.4.3 Terminology

Throughout the following scenario all business object names will be capitalized and underlined the first time they are introduced—thus: PROSPECT. Thereafter just the first letter will be capitalized and the object name underlined as a constant reminder that this is a business object.

For simplicity in this example we minimize the number of Roles, referring only to PROSPECT MANAGER, ALLOCATOR and RESOURCE. In this scenario we assume that the business process owner has decided that the role ‘Prospect Manager’ shall handle what could have been alternatively named as three separate three sub-roles—namely Assessor, Team-builder and Contact-Coordinator.

This is a nice example of retention of a little ‘centralized’ thinking—to some extent the three roles are at the Prospect manager role ‘responsibility hub’—but who shall assume that role can be changed at any time as the process progresses. Retention of some hierarchical and centralized thinking is usual during the transition to the new competence-centric form of organization.

H.4.4 Multiple Roles

The several roles, for a given Prospect, are often played by one person. Thus, for a given Prospect instance, Annika might take both the Prospect Manager role and a Resource role—that decision will be made by the Allocator role when Annika (in her role of Prospect manager) specifies the required COMPETENCE.

H.4.5 How the Example Prospect Pursuit Process Begins

The assignment of the Prospect in question to Annika in the first place was the last step of the previous process called ‘Inspiring Customer’.

The Business Process Owner (responsible for the specification of the process) has decided that the ‘Pursuing Prospect’ process formally begins when the Prospect Manager role (in this case assumed by Annika) begins the first Assessment task (for the specific Prospect instance). The purpose of the Assessment process is to control release of Funds to pay (by internal accounting) for Resources that will pursue each specific Prospect.

H.4.6 Development of the Three Object-Engineered Supporting Processes

Recall that the invention is the competence-centric organization and radio-enabled information system required for execution of the Assessing, Building team and Coordinating Contact Occasion supporting processes.

H.4.6.1 Use Case Model

As its name suggests a ‘Use case’ is used. A Use case is always used by an Actor.

See Drawing 12: Use Case Model

By definition an Actor must gain a result of value by using the Use case. Delivery of this result is achieved by ‘realization’ of the Use case. The decision Influencer (usually employed within the CUSTOMER team) must find this process efficient and effective in his/her role as an Influencer. Once the Actor-Use case relationships are mapped, the Use case must be ‘realized’ by collaboration between business objects. Objects collaborate by sending messages and receiving messages as the following example shows.

H.4.6.2 ‘Assessing’ Supporting Use case

Just as diagnosis and treatment often require different competencies so it is with assessment of the Prospect (by the Prospect Manager) and the execution of pursuit action (by the Resource).

Assessing can be represented by the collaboration between the Prospect Manager, PROSPECT BANK, Prospect, BUSINESS PARTY, INFLUENCE, PERSON and PROSPECT PURSUIT BUDGET objects in the sequence shown on the connecting arrows.

See Drawing 13: ‘Assessing’ Supporting Use Case

This process example requires certain capabilities of executing activities. For example Step #6 (Select prospect) requires that the Prospect manager decide which Prospect to prioritize. This is discussed further in section 1.5.6.2.

Not surprisingly the ‘Assessing’ process formally begins at ‘Start Assessment’ (see ‘START’ above).

One might wonder what triggers Annika to ‘start’?

She may get a phone call from a team colleague to inform her that an event has occurred that requires her to ‘Assess’ the Prospect again

or,

in a highly automated ‘Assessing’ process, she may receive a SMS message on her mobile telephone (how this is achieved technically comes later . . . ).

See Drawing 14: Notification

This was an introduction to object collaboration using the Assessing process as an example. There are corresponding sequences for the other two sub-processes (Building team and Coordinating contact occasion).

H.4.6.3 ‘Building Team’ Supporting Use Case

In Building team, the Prospect manager role specifies the required Competence of the Resource being requisitioned to the team. But it is the ALLOCATOR role that decides which PERSON shall fill that Resource role by checking the AVAILABILITY (another new object) of the alternative Resources then proceeding to adding a team member. A typical Building team object collaboration diagram is provided in the appendices—this model is not intended to be studied in detail but just to indicate the appearance of several more objects.

See Drawing 15: Object Collaboration Diagram—Allocating

Building team is a reiterative process. In the example below there is a team to pursue a milking system Prospect at the Dancing Bull Ranch.

At any point in time there may be a team (Kristina Lund and Hans Welander) and outstanding requests for further Competence (Product/Service Engineer still to be filled).

See Drawing 16: ‘Building Team’ Supporting Use Case

H.4.6.4 ‘Coordinating Contact Occasion’ Supporting Use Case

A typical Coordinating contact occasion collaboration diagram is provided in the appendices.

See Drawing 17: Object Collaboration Diagram—Coordinating Contact Occasion

A CONTACT OCCASION may be represented in the following way:

See Drawing 18:‘Coordinating Contact Occasions’Supporting Use Case

In the Coordinating contact occasion sub-process it has been decided (by the ‘Business Process Owner’) that the Prospect manager role shall take the responsibility for coordinating Contact occasions. This includes deciding who shall be invited and who are the essential participants that must accept the invitation before the meeting is confirmed. Note that two of the meeting participants are from the Customer organization (Dancing Bull Ranch) and one from the Vendor company (Beta Laval). The Customer has a team too! One reason for the anticipated effectiveness and efficiency shifts by the proposed process reengineering is that the Customer will take a much more active role in the overall selling process—for mutual benefit. The information system (see later) must therefore enable dialogue with the Customer—not only in the Pursuing Prospect process but also in other core marketing/sales processes (not elaborated here).

See Drawing 19: Participation Object

Especially important is that objects can be considered to have states, and that progress in processes may be tracked/measured according to state-transitions. For example, the allowable ‘states’ of a Contact occasion object include ‘intended’, ‘proposed’ and ‘committed’. Allowable ‘states’ of the PARTICIPATION object (shown above) are ‘desired’, ‘invited’, ‘reserved’, ‘confirmed’ and ‘withdrawn’.

In order to keep a record of the meeting, ‘attended’ would be another required state. This Participation object thus has the potential to record the time that the Resource was occupied—either for billing the Customer (if the Contact Occasion is a service call for example) and/or for internal cost tracking necessary to determine profitability of each Customer.

The factor most responsible for tedious co-ordination of meetings (or scheduling service visits) is delays in responding to the invitation. Therefore when the Participation state is changed from ‘desired’ to ‘invited’ it's important that the invitee is made aware of the invitation and responds quickly. This explains the notation ‘Notification required’ in the diagram.

See Drawing 31: State Transition Notification Message Request

The system engineer is requested to find a way to alert the invitee and facilitate an accept/decline response that can be incorporated into the database en route to sharing with all team members. Thus, ten minutes after an invitation message is sent the system can check whether a reply has been received. If not further follow-up action can be initiated.

See Drawing 32: Object Collaboration_Expedite Request

H.4.7 Competence-Centric Organization

H.4.7.1 Process-Management Orientation

The following diagram illustrates a single instance of a Prospect pursuit in which Resources from two (Product and Sales) of the three competence centers (Application, Product and Sales) participate.

See Drawing 5: Process Management Orientation

Already the involvement of several ‘roles’ in the Pursuing Prospect process have been mentioned—Prospect manager, Allocator and Resource. In a pure competence-centric organization all of these roles would be filled by requisition from a competence center. A competence center is not a physical site but a virtual grouping of employees based on primary competence into which personnel are recruited, trained, motivated and rewarded based on the performance of the teams of which they become members.

The Allocator role would be especially aware of the skills available in the various competence centers. Selection of the appropriate Person as a Resource in any instance would be governed by Competence to perform the ‘activities’ defined by the Business Process Owner.

H.4.7.2 Specification of the Prospect Manager Object (For Example)

The person who manages the competence center is made aware, in a highly structured way, of which activities are to be performed by each role. This is part of the formal specification of the role (such as Prospect manager) object.

A role object must have the Competence to conduct ‘activities’ assigned to that role by the Business Process Owner. Recalling that (in this example) the Prospect manager role covers Assessor, Team Builder and Contact occasion coordinator roles it is not surprising that the Prospect manager specification includes a wide range of activities derived from collaboration in several processes.

Notice that all the various activities, of which the Prospect manager role must be capable, occur in one or more of the object collaboration diagrams for the use cases in which the Prospect manager participates.

This object-oriented approach clearly gives a ‘language’ (for example UML) in which the business process engineer and the organization consultant may communicate.

See Drawing 20: Specification of the Prospect Manager Object

The overall Pursuing process ends when the Customer has made a decision. Each sub-process also has an end, as shown in the following Assessing process example that ends when the Pursuit budget has been updated.

One can see instantly how much the Account manager (role object) is prepared to invest to secure this business (Ceiling 10 000), how much the Prospect manager has released to the Allocator (Funded 10 000) and what Resources have been ‘allocated’ on a contingent basis (2700).

See Drawing 21: Resource Budget

H.4.8 The Information System

H.4.8.1 Physical Description

See Drawing 22: Information System—Physical Description

At a high level the information system enables communication in five ways:
Mobile distributed databases maintained by replication over radio—here is the primary access by vendor team-members having allocated roles.
Internet access to a web-server on which the database is also maintained by replication—this would probably be the main route for Customers.
Local LAN for office-resident participants.
Dial-up access to the LAN in two situations—firstly, by field resources wishing to access information not replicated to their stations and, secondly, by occasionally participating resources for which it is not considered worthwhile to set up a distributed database.
Notification that may be by SMS to mobile phone/communicator, or by the more traditional E-Mail and/or Fax.

See Drawing 23: System Network and Devices

There is great flexibility in deployment of servers and devices. This is represented in the example by considering the MPS provider and MPU domains as ‘sliding windows’.

See Drawing 24: MPS Provider and MPU Domains

H.4.8.2 User Interface

Since almost all user access to data is local (reading the distributed database) the screen response is instantaneous.

The user interface, created automatically from the system object-oriented model is process oriented—so if the user wishes to conduct the Pursuing Prospect process the way in is by clicking on the Pursuing Prospect icon.

See Drawing 25: Information System—User Interface

Expert system language translation technology can have a dramatic effect on global scalability. Resources working in multi-national account teams can work in their own language and have dialogue with colleagues in other countries automatically translated.

See Drawing 46: Expert System Language Translation

H.4.8.3 Databases

See Drawing 26: Data Model

The database within an information system can be considered as a collection of tables. The table T-Person is simply a list of people. T-Prospect is a list of prospects. In addition to ‘self information’ such tables also carry cross-references to related tables, that's why it's called a ‘relational’ database. Some tables are more abstract in nature—for example T-Influence that is simply a list of pairs—a Prospect and a Person:

See Drawing 27: Influence Table

The T-Participation table is very similar—it shows which people ‘participate’ in meetings.

A data table is extremely efficient for representing information. In the context of this invention such relational databases are an important background technicality because the sending of a few characters over radio to update a remote database can convey dramatic changes in the information.

Such highly efficient communication of information, especially when necessary over radio, is in contrast to the redundancy of communicating in text form over E-Mail.

H.4.8.4 Replication

Speed of data transmission is irrelevant for distributed databases—whether it takes ten or twenty seconds to background-update a database has zero negative effect on functionality. If a distributed database approach is taken, ‘fair’ (say 80%) coverage will be adequate in most cases because databases will be synchronized and notification messages will be received as the worker travels into and out of coverage. In the worst case synchronization can occasionally be made over wire-line if out of coverage for long periods of time.

The elaboration of which objects participate in which process activities conducted by which roles is also important to ensuring that the right system objects are physically available to the resource that must capture and/or read information. Because the data will be replicated and communicated by radio (which is expensive and slow), distribution rules must be established to ensure that the essential system objects are physically distributed to the appropriate stations.

For example, the rules for replication to a resource having role of Allocator may be as follows:
In this example neither Contactoccasion, nor Influence, nor Participation data is distributed to the Allocator because it is considered unnecessary for the Allocator to have information about Contactoccasions (meetings with the Customer) or Influence (the reference to which people influence the purchase decision in active Prospects).
Some data is conditionally replicated—for example Person is limited to the employees of the Vendor company (“our company”).
Other data is entirely replicated—for example the identification of all Prospect managers and all Availability of all Resources.

See Drawing 28: Replication Rule Formulation

H.4.8.5 Communication Middleware

Modern middle-wares, such as EVO from Ericsson, provide transparent inbound/outbound access to a wide variety of radio networks (and wire-line).

See Drawing 29: Communication Middle Ware—Physical

Today such technology is applied almost exclusively to E-Mail because of its encryption, compression and other efficiency attributes. But the ability to dynamically swap between transport providers, for example between packet- and circuit-switched, is not exploited.

See Drawing 30: Communication Middleware—Logical

In this implementation example, let's say it's in Sweden, GSM coverage in the cities is highly developed and until recently was the only way to send data over radio from portable devices. GSM is, and will continue to be, the network of choice when sending more than 3K. Relatively slow Mobitex (1.2K) on the other hand has total national coverage but requires heavy equipment and a long antenna—but it's suitable for vehicle-mounted operation. The recent introduction of faster (8K) and more portable (PCMCIA modems in PCs) used with Mobitex 8K in Stockholm and Gothenburg supersedes 1.2K Mobitex—having the further advantage of giving indoor coverage.

Middle-ware as described here allows all of these transports, including the soon-to-be-released GPRS, to be invoked—the application is totally shielded from the transport provider.

H.4.8.6 Notification Messages

In event-driven processes (rather than in reliably/predictably planned processes) changes of state are often beyond the control of the resource conducting the process—then states tend to be ‘observed’ (and responded to) rather than ‘caused’ by the process worker. It is the process by which observations of these states, and communication of such observations within and between process teams, that enables process effectiveness and efficiency gains to be made.

In this example the business process engineer asks the system engineer to program a triggered automatic notification (by a mobile phone SMS message) to a resource invited to a meeting—this is because an immediate response of acceptance or decline is needed to speed up the ‘Coordinating contact occasion’ process.

See Drawing 31: State Transition Notification Message Request

Here the business process engineer emphasizes that both invitation and acceptance should be rapid.

See Drawing 32: Object Collaboration—Expedite Request

One way of achieving this technically is by DBMS triggers.

The application for patents is limited to event-driven processes (such as marketing, sales and service).

H.4.8.7 Customer Web Server

See Drawing 33: Customer May Access Over Webserver

One of the most important aspects of the invention is that the so-called ‘Team approach’ is customer-centric. The creation of customer-intimacy in which the customer is considered to be a team-member is critical.

Sales and service personnel working in the field have their own devices on which distributed databases are physically located and maintained. Theoretically every customer, and indeed every employee of every customer, could have her/his own distributed database—but that is not practical. More usual is for customers to read and write information to/from a Customer Web Server.

In this manner the customer is empowered (by password and appropriate rules) to read and write to the Customer Web Server's database that resides at the vendor companies' central location. In the example shown here the customer can take the responsibility for maintaining certain data-like telephone number.

The customer can now participate directly in processes—for example the ‘Coordinating contact occasion’ process. Either the customer or the salesman can initiate a meeting and proposed participants can dialogue to set mutually appropriate date and time.

1. Resolution of the Productivity Paradox of Information Technology by a mobile process service (abbreviated to MPS) that increases the effectiveness and efficiency of any (main or supporting) event-driven, business-to-business (abbreviated to B2B) mobile, processes and is realized by combining three components:
object-engineered processes (abbreviated to P),
competence-centric organizations (abbreviated to O), and
an information handling software that includes distributed relational databases maintained over radio (abbreviated to S);
furthermore this claim is made only when all three components (P, O and S) are invoked and offered as a MPS, rather than as individual components, since it is the synergy between multi-disciplines (P, O and S) that is claimed as innovative and not obvious.

2. Mass customization of the mobile process service of claim-1 by rapid application development (RAD) wherein the object-oriented model of the intended business process and organization shall semi-automatically create system models (including data models) and these system models shall be one input for semi-automatic creation of the system executable programs (optionally including replication rules and triggers) to be employed as a component of the ultimate mobile process service (MPS) the intention being that such automation makes mass customization (for each individual end-user company) of processes economically feasible.

3. An ‘ABC’ refinement of the mobile process service of any preceding claim in which the main processes are enhanced by invoking three engineered supporting processes:
Assessing (abbreviated to A),
Building team (abbreviated to B), under the conditions that
a) participant competence centers are within a single organization, or if
b) several companies cooperate by allowing one or more companies to requisition resources from another's virtual, or more formal, competence centers (for example when a company requisitions resources from an up- or down-stream channel member), or if
c) partner companies agree that resources in one company will conduct processes traditionally performed by the other (for example, if a service organization spots sales leads for the selling company), or if
d) partner companies (for example one being a vendor of capital equipment and the other a vendor of related supplies) share the activities and information related to the customer, or if
e) two or more vendor companies co-fund and collaboratively conduct the marketing/sales of a solution that utilizes the products/services from such participating vendors.
Coordinating contact occasions (abbreviated to C).
furthermore this claim is made only when all three components (A, B and C) are invoked since it is the synergy between these three processes that is claimed as innovative and not obvious.

4. An interface database that enables a refinement of the mobile process service (MPS) of any preceding claim, inserted as an information link between
the resource team-members as engaging in preceding claims, and
the so-called ‘back-office’ (or other) information storage sites
the interface database being a replicated subset of the primary database, the latter maintained at the data center, wherein the interface database contains only those data elements flowing between the teams in the field and the back-office (or other) information storage sites, there being an option for the interface database to reside either at the data center of the mobile process service provider or at the premises of the mobile process user (MPU).

5. Worldwide deployment of the mobile process service of preceding claims, economically scalable, and achieved by information communication technology (ICT) wherein the data flow is orchestrated by data service (DS) from a single data center, and delivery executed by network service (NS) through, usually national, carriers to the teams in the local, usually national, field sites.

6. A selling process that is dependent on any preceding claim and has the following sequence of sub-processes:
understanding customer fulfillment (abbreviated to UCF), in which Need and Solution are explicitly represented as business objects and Fulfillment (satisfaction) represents the relationship, with associated ‘states’ between Need and Solution reflecting the customer satisfaction level,
inspiring customer (abbreviated to IC), and
pursuing prospect (abbreviated to PP)

7. A mobile process service that globally deploys the SELLING process (which is a main, event-driven, B2B process) and is dependent on any preceding claim; the claimed delivering process service supports sub-processes that include, but are not limited to:
understanding customer fulfillment (abbreviated to UCF),
inspiring customer (abbreviated to IC), and
pursuing prospect (abbreviated to PP)

8. A mobile process service that globally deploys the DELIVERING process (which is a main, event-driven, B2B process) and is dependent on any preceding claim; the claimed delivering process service supports sub-processes that include, but are not limited to:
recognising (abbreviated to RE),
planning (abbreviated to PL),
committing and dispatching (abbreviated to CD),
delivering (abbreviated to DE),
documenting (abbreviated to DO),
financial transactions (FT).

9. The organization and mechanisms to grow a market for mobile process service as articulated in the preceding claims, then explicit capture of a fair share of the value created during execution of any of the preceding claims within the telecom industry, by establishing telecom infrastructure providers as Franchisers that will:
appoint expert resources by certification to design, construct and deploy the mobile process service for the business-to-business (B2B) mobile process users (MPUs);
appoint ‘Inspiration Franchisees’ that will build the market for these mobile process services;
appoint ‘System Service’ franchisees that will be responsible for constructing and continuously updating the system consisting of processes, organization and software;
appoint ‘ICT Service’ franchisees that will be responsible for operating the system that distributes the data by radio and/or wire-line communication as a mobile process service (MPS),
all this being explicitly such that the Franchiser may, at its discretion, appoint companies (such as network operators) as ICT Service franchisees that are customers, or potential customers, for products and services (such as base-stations) offered by the Franchiser and thus capture value indirectly.

10. A service specific basis for billing the user for mobile process service support to each instance of the process articulated in any of the preceding claims which may include, but are not limited to, a specific charge for supporting each selling instance, or each delivering instance, or each assessing instance, or each building team instance, or each coordinating contact occasion instance. This is in contrast to billing for products (like computer hardware), consulting services (utilized to design the system), horizontal applications (such as E-mail) and low-level service (such as time on the network or packets of data transported).

11. An inter-franchisee pricing mechanism, dependent on any of the preceding claims, mandated by the Franchiser such that all members of the channel, including certified expert resources, Inspiration Franchisees, System Service Franchisees and ICT Franchisees will be remunerated partly at the time when services are delivered to the next downstream level in the channel (for example when the system simulator is delivered to ICT provider) and partly at the time when the mobile process service is delivered to the mobile process user.
